(19) United States
(12) Patent Application Publication
(10) Pub. No.: US 2024/0296423 A1
(43) Pub. Date: Sep. 5, 2024

(54) INFORMATION PROCESSING APPARATUS, INFORMATION PROCESSING METHOD, AND NON-TRANSITORY COMPUTER READABLE MEDIUM

(71) Applicants: TOYOTA JIDOSHA KABUSHIKI KAISHA, Toyota-shi Aichi-ken (JP); DENSO CORPORATION, Kariya-city Aichi-pref (JP)

(72) Inventors: Yu NAGATA, Chofu-shi Tokyo-to (JP); Keiichi Uno, Kariya-city Aichi-pref (JP)

(73) Assignees: TOYOTA JIDOSHA KABUSHIKI KAISHA, Toyota-shi Aichi-ken (JP); DENSO CORPORATION, Kariya-city Aichi-pref (JP)

(21) Appl. No.: 18/591,199

(22) Filed: Feb. 29, 2024

(30) Foreign Application Priority Data
Mar. 2, 2023 (JP) 2023-032247

(51) Int. Cl. G06Q 10/105

(52) U.S. Cl. CPC G06Q 10/105

(57) ABSTRACT

An information processing apparatus includes a controller. The controller executes operations that include acquiring crew member information from a crew member terminal of a crew member of a vehicle, extracting a feature value from the crew member information, calculating the degree of deviation by comparing the feature value with a normal value, determining whether the crew member can be on board based on whether the degree of deviation exceeds a threshold value, notifying a manager terminal of a primary determination result including whether the crew member can be on board, and acquiring, from the manager terminal, a final determination result on whether the crew member can be on board.

### CROSS-REFERENCE TO RELATED APPLICATION

This application claims priority to Japanese Patent Application No. 2023-032247, filed on Mar. 2, 2023, the entire contents of which are incorporated herein by reference.

### TECHNICAL FIELD

The present disclosure relates to an information processing apparatus, an information processing method, and a program.

### BACKGROUND

Conventionally, technology for performing roll call processing by acquiring vital data 31 of crew members 3 from crew member terminals 30, performing voice pathological analysis with voice data 32, which includes voice uttered by the crew members 3, acquired from the crew member terminals 30, presenting information regarding the crew members 3 to a manager terminal 40, and accepting information input by a manager 4 as to whether each crew member 3 is workable is known. For example, see Patent Literature (PTL) 1.

### CITATION LIST

### Patent Literature

PTL 1: JP 2018-180609 A

### SUMMARY

The above technology requires a manager to check the condition of all crew members. This places a heavy burden on the manager.

It would be helpful to reduce a burden of determination on a manager.

An information processing apparatus according to an embodiment of the present disclosure is an information processing apparatus including a controller configured to execute operations, the operations including:
acquiring crew member information from a crew member terminal of a crew member of a vehicle;
extracting a feature value from the crew member information;
calculating the degree of deviation by comparing the feature value with a normal value;
determining whether the crew member can be on board based on whether the degree of deviation exceeds a threshold value;
notifying a manager terminal of a primary determination result including whether the crew member can be on board; and
acquiring, from the manager terminal, a final determination result on whether the crew member can be on board.

An information processing method according to an embodiment of the present disclosure is an information processing method by an information processing apparatus, the information processing method including:
acquiring crew member information from a crew member terminal of a crew member of a vehicle;
extracting a feature value from the crew member information;
calculating the degree of deviation by comparing the feature value with a normal value;
determining whether the crew member can be on board based on whether the degree of deviation exceeds a threshold value;
notifying a manager terminal of a primary determination result including whether the crew member can be on board; and
acquiring, from the manager terminal, a final determination result on whether the crew member can be on board.

A program according to an embodiment of the present disclosure is configured to cause a computer, as an information processing apparatus, to execute operations, the operations including:
acquiring crew member information from a crew member terminal of a crew member of a vehicle;
extracting a feature value from the crew member information;
calculating the degree of deviation by comparing the feature value with a normal value;
determining whether the crew member can be on board based on whether the degree of deviation exceeds a threshold value;
notifying a manager terminal of a primary determination result including whether the crew member can be on board; and
acquiring, from the manager terminal, a final determination result on whether the crew member can be on board.

According to an embodiment of the present disclosure, a burden of determination on a manager can be reduced.

### BRIEF DESCRIPTION OF THE DRAWINGS

FIG. 1 is a schematic diagram of an information processing system according to the present embodiment;

FIG. 2 is a block diagram illustrating a configuration of an information processing apparatus;

FIG. 3 is a block diagram illustrating a configuration of a vehicle;

FIG. 4 is a block diagram illustrating a configuration of a crew member terminal;

FIG. 5 is a block diagram illustrating a configuration of a manager terminal;

FIG. 6A is a sequence diagram illustrating first operations of the information processing system;

FIG. 6B is a sequence diagram illustrating a continuation of FIG. 6A;

FIG. 7 is a diagram illustrating a data structure of a crew member information database;

FIG. 8 is a diagram illustrating a display screen on the manager terminal; and

FIG. 9 is a sequence diagram illustrating second operations of the information processing system.

### DETAILED DESCRIPTION

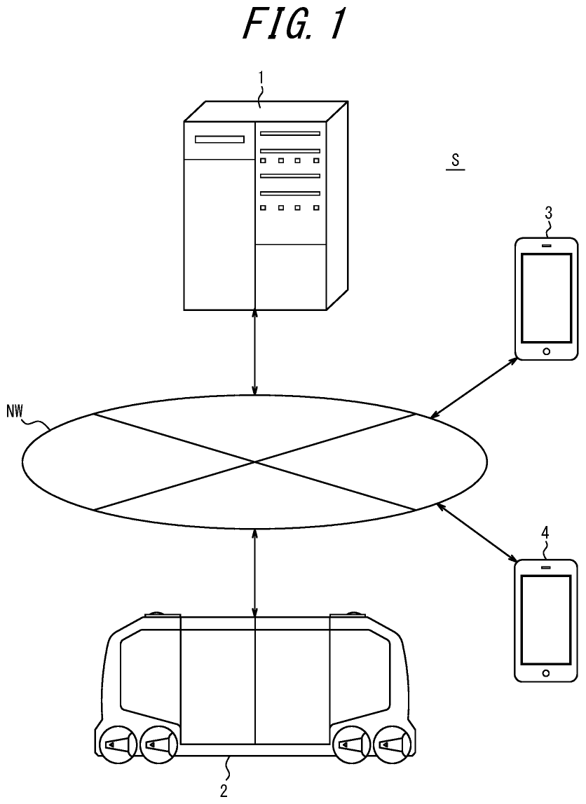

FIG. 1 is a schematic diagram of an information processing system S according to the present embodiment. The information processing system S includes an information processing apparatus 1, a vehicle 2, a crew member terminal 3, and a manager terminal 4, which are communicably connected to one another via a network NW. The network NW includes, for example, a mobile communication network, the Internet, or a fixed communication network.

FIG. 1 illustrates one each of the information processing apparatus 1, the vehicle 2, the crew member terminal 3, and the manager terminal 4, for convenience of explanation. However, the numbers of information processing apparatuses 1, vehicles 2, crew member terminals 3, and manager terminals 4 are not limited to one. For example, processing to be executed by the information processing apparatus 1 may be executed by a plurality of distributed information processing apparatuses 1. The information processing apparatus 1 may be capable of communicating with a plurality of vehicles 2. A plurality of vehicles 2, a plurality of crew member terminals 3, and a plurality of manager terminals 4 may be connected to the network NW.

An outline of processing executed by the information processing apparatus 1 of the present embodiment will be described. A controller 11 of the information processing apparatus 1 executes operations that include acquiring crew member information from the crew member terminal 3 of a crew member of the vehicle 2, extracting feature values from the crew member information, calculating the degree of deviation by comparing the feature values with normal values, determining whether the crew member can be on board based on whether the degree of deviation exceeds a threshold value, notifying the manager terminal 4 of a primary determination result including whether the crew member can be on board, and acquiring, from the manager terminal 4, a final determination result on whether the crew member can be on board. With this configuration, since the information processing apparatus 1 makes primary determination, the manager (for example, operation management supervisor) can make final determination by only determining whether at least crew members who are in poor physical condition can be on board. Thus, the information processing apparatus 1 can reduce a burden of determination on the manager. Furthermore, the information processing apparatus 1 can reduce the need for an assistant of the manager. Furthermore, since the information processing apparatus 1 makes the primary determination, it is possible to reduce situations in which the determination result depends on the experience or physical condition of the manager.

The information processing apparatus 1 may be a server configured to assist a provider in providing a service. The information processing apparatus 1 may be, for example, installed in a facility dedicated to the provider or in a shared facility including a data center. As an alternative example, the information processing apparatus 1 may be mounted in the vehicle 2. The information processing apparatus 1 may be referred to as a center server or a roll call system.

The vehicle 2 includes, for example, any type of automobile such as a gasoline vehicle, a diesel vehicle, an HEV, a PHEV, a BEV, or an FCEV. The term “HEV” is an abbreviation of hybrid electric vehicle. The term “PHEV” is an abbreviation of plug-in hybrid electric vehicle. The term “BEV” is an abbreviation of battery electric vehicle. The term “FCEV” is an abbreviation of fuel cell electric vehicle. The driving of the vehicle 2 may be automated at any level. The automation level is, for example, any one of Level 1 to Level 5 according to the level classification defined by SAE. The name “SAE” is an abbreviation of Society of Automotive Engineers. The vehicle 2 may be a MaaS-dedicated vehicle. The term “MaaS” is an abbreviation of Mobility as a Service. Alternatively, the vehicle 2 may be driven by a driver.

Each of the crew member terminal 3 and the manager terminal 4 includes, for example, a mobile device such as a smartphone, a mobile phone, a wearable device, or a tablet. As an alternative example, each of the crew member terminal 3 and the manager terminal 4 may be a general purpose device such as a PC or a dedicated device. The term “PC” is an abbreviation of personal computer.

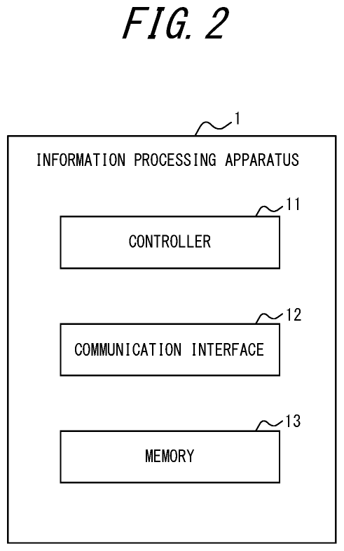

In FIG. 2, an internal configuration of the information processing apparatus 1 will be described in detail.

The information processing apparatus 1 includes the controller 11, a communication interface 12, and a memory 13. The components of the information processing apparatus 1 are communicably connected to one another via, for example, dedicated lines.

The controller 11 includes, for example, one or more general purpose processors including a Central Processing Unit (CPU) or a Micro Processing Unit (MPU). The controller 11 may include one or more dedicated processors that are dedicated to specific processing. The controller 11 may include one or more dedicated circuits instead of the processors. Examples of the dedicated circuits may include a Field-Programmable Gate Array (FPGA) and an Application Specific Integrated Circuit (ASIC). The controller 11 may include an Electronic Control Unit (ECU). The controller 11 transmits and receives any information via the communication interface 12.

The communication interface 12 includes, for connecting to a network, one or more communication modules that conform to wired or wireless LAN (Local Area Network) standards. The communication interface 12 may include a module conforming to one or more mobile communication standards including the Long Term Evolution (LTE) standard, the 4th Generation (4G) standard, or the 5th Generation (5G) standard. The communication interface 12 may include one or more communication modules conforming to near field communication standards or specifications, including Bluetooth® (Bluetooth is a registered trademark in Japan, other countries, or both), AirDrop® (AirDrop is a registered trademark in Japan, other countries, or both), IrDA, ZigBee® (ZigBee is a registered trademark in Japan, other countries, or both), Felica® (Felica is a registered trademark in Japan, other countries, or both), or RFID. The communication interface 12 transmits and receives any information via the network.

The memory 13 includes, for example, a semiconductor memory, a magnetic memory, an optical memory, or a combination of at least two of these, but is not limited to these. The semiconductor memory is, for example, RAM or ROM. The RAM is, for example, SRAM or DRAM. The ROM is, for example, EEPROM. The memory 13 may function as, for example, a main memory, an auxiliary memory, or a cache memory. The memory 13 may store information resulting from analysis or processing performed by the controller 11. The memory 13 may store various types of information or the like regarding operations and control of the information processing apparatus 1. The memory 13 may store a system program, an application program, embedded software, and the like. The memory 13 may be provided outside the information processing apparatus 1 and accessed by the information processing apparatus 1. The memory 13 includes a crew member information database.

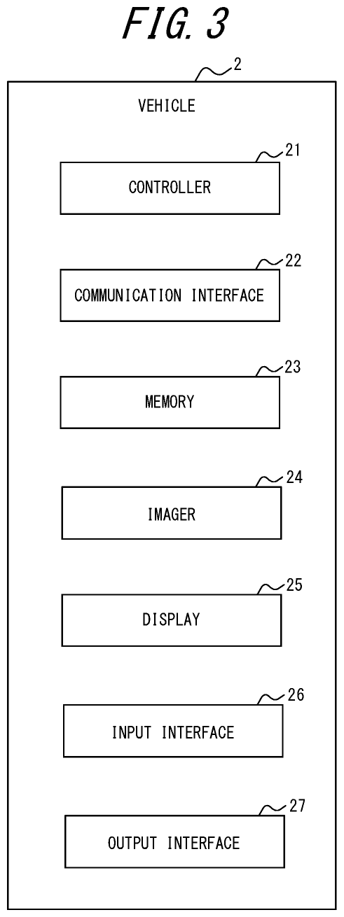

In FIG. 3, an internal configuration of the vehicle 2 will be described in detail.

The vehicle 2 includes a controller 21, a communication interface 22, a memory 23, an imager 24, a display 25, an input interface 26, and an output interface 27. The components of the vehicle 2 are communicably connected to one another, for example, via dedicated lines.

Descriptions of the hardware configurations of the controller 21, the communication interface 22, and the memory 23 may be the same as the descriptions of the hardware configurations of the controller 11, the communication interface 12, and the memory 13, respectively. A description here is omitted.

The vehicle 2 according to the present embodiment performs automated driving. The memory 23 of the vehicle 2 stores Autonomous Driving Kit (ADK) software for the automated driving and conductor software.

The imager 24 includes cameras and captures images. The images may be either still images or moving images. The imager 24 may generate the images and record the generated images in the memory 23. The imager 24 may include cameras to assist in remote operations of the vehicle 2 and surveillance cameras for a conductor.

The display 25 is, for example, a display. The display is, for example, an LCD or an organic EL display. The term “LCD” is an abbreviation of liquid crystal display. The term “EL” is an abbreviation of electro luminescence. The display 25 may be connected to the vehicle 2 as an external output device, instead of being provided in the vehicle 2. As a connection method, any technology such as USB, HDMI® (HDMI is a registered trademark in Japan, other countries, or both), or Bluetooth® can be used. The term “USB” is an abbreviation of Universal Serial Bus. The term “HDMI®” is an abbreviation of High-Definition Multimedia Interface. The display 25 may be a signage. The display 25 may be a touch panel.

The input interface 26 is, for example, a microphone, a physical key, a capacitive key, a pointing device, or a touch screen integrally provided with a display. The input interface 26 accepts an operation for inputting information to be used for the operations of the vehicle 2. The input interface 26 may be connected to the vehicle 2 as an external input device, instead of being provided in the vehicle 2. As a connection method, any technology such as USB, HDMI®, or Bluetooth® can be used.

The output interface 27 includes at least one output interface for outputting information to notify a user of the information. For example, the output interface included in the output interface 27 is a speaker for outputting the information in the form of audio, or the like, but is not limited to this. For example, the output interface 27 may be any broadcast device.

The vehicle 2 may further include sensors. The vehicle 2 may further include a calling device for calls between passengers and an operator of the information processing apparatus 1. The vehicle 2 may further include various buttons for bus operations.

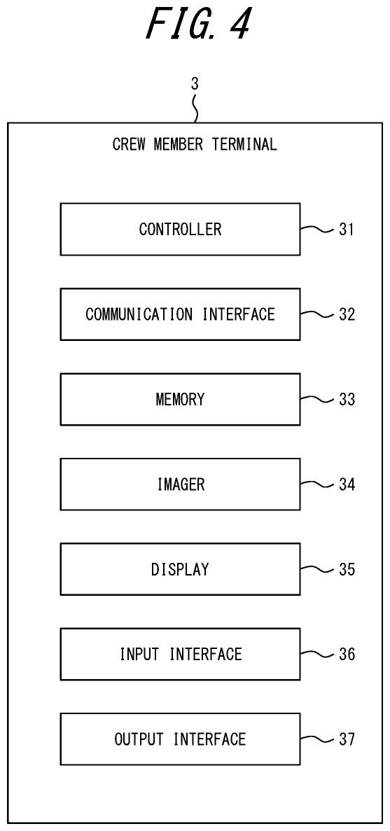

In FIG. 4, an internal configuration of the crew member terminal 3 will be described in detail.

The crew member terminal 3 includes a controller 31, a communication interface 32, a memory 33, an imager 34, a display 35, an input interface 36, and an output interface 37. The components of the crew member terminal 3 are communicably connected to one another, for example, via dedicated lines.

Descriptions of the hardware configurations of the controller 31, the communication interface 32, the memory 33, the imager 34, the display 35, the input interface 36, and the output interface 37 of the crew member terminal 3 may be the same as the descriptions of the hardware configurations of the controller 21, the communication interface 22, the memory 23, the imager 24, the display 25, the input interface 26, and the output interface 27 of the vehicle 2, respectively. A description here is omitted.

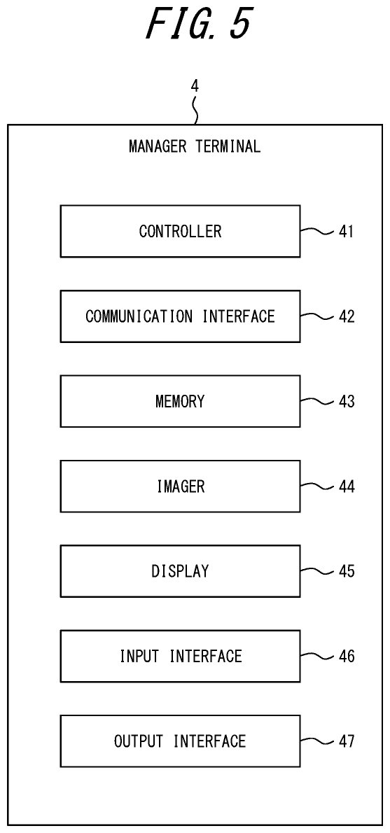

In FIG. 5, an internal configuration of the manager terminal 4 will be described in detail.

The manager terminal 4 includes a controller 41, a communication interface 42, a memory 43, an imager 44, a display 45, an input interface 46, and an output interface 47. The components of the manager terminal 4 are communicably connected to one another, for example, via dedicated lines.

Descriptions of the hardware configurations of the controller 41, the communication interface 42, the memory 43, the imager 44, the display 45, the input interface 46, and the output interface 47 of the manager terminal 4 may be the same as the descriptions of the hardware configurations of the controller 31, the communication interface 32, the memory 33, the imager 34, the display 35, the input interface 36, and the output interface 37 of the crew member terminal 3, respectively. A description here is omitted.

Hereinafter, an information processing method executed by the information processing system S according to the present embodiment will be described in detail. As an example here, an operator of the information processing apparatus 1 installed in a control center monitors the vehicles 2 on a monitor screen. The vehicles 2 here are plural, but may be singular as an alternative example. For convenience of explanation, each of the plurality of vehicles 2 is referred to as the vehicle 2.

The vehicles 2 are driven by crew members who are on board the vehicles 2. The vehicles 2 here are buses. As an alternative example, the vehicles 2 may be other passenger vehicles, freight vehicles, or automated vehicles that are remotely monitored. Each crew member operates the crew member terminal 3. The crew members are managed by a manager. The manager here is singular, but may be plural. The manager is also referred to as operation management supervisor. The manager operates the manager terminal 4.

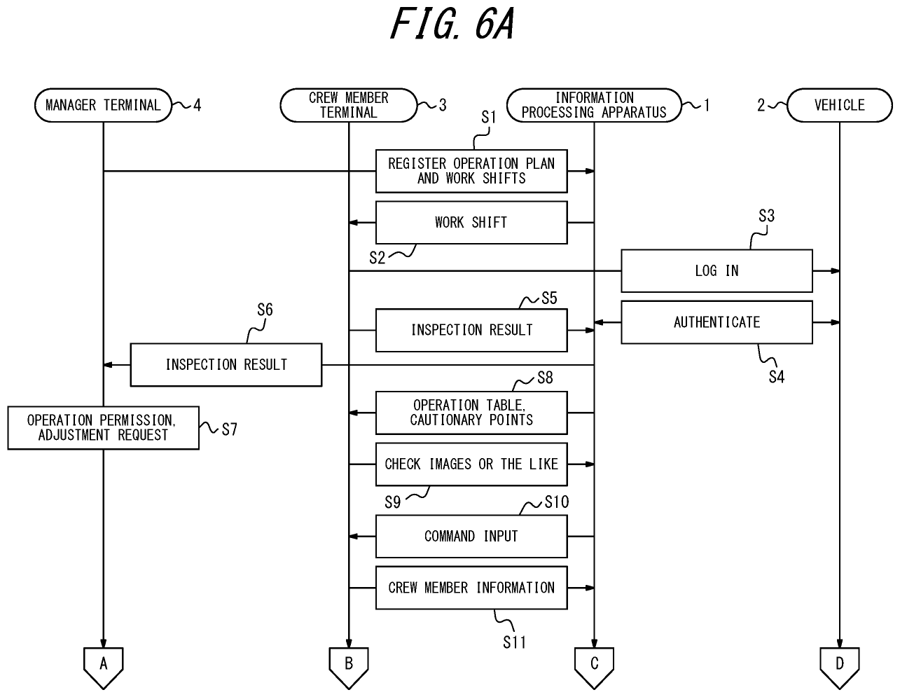

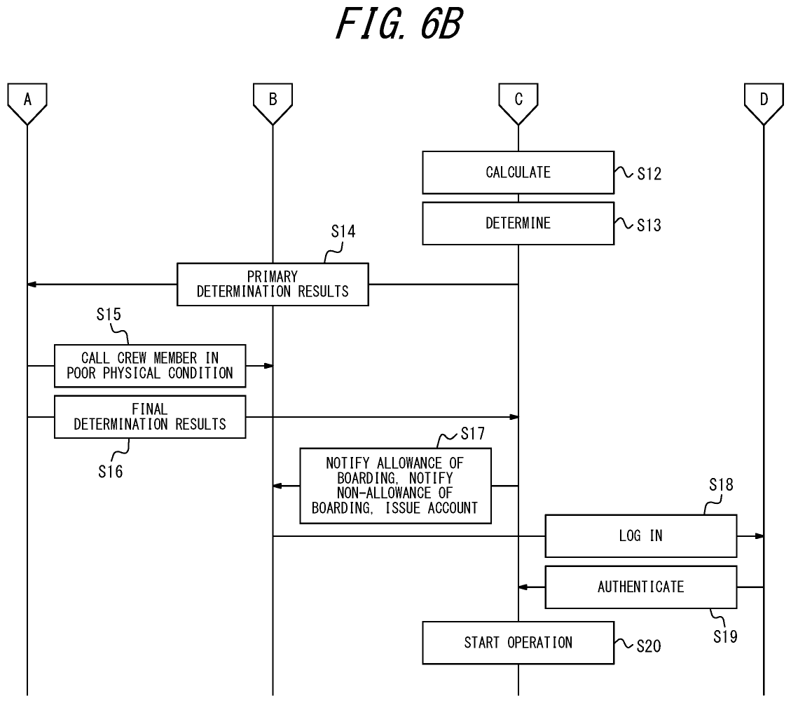

In step S1 of FIG. 6A, the controller 11 of the information processing apparatus 1 accepts, from the manager terminal 4, registration of an operation plan and work shifts. In step S2, the controller 11 notifies the crew member terminals 3 of the work shifts. In step S3, each crew member terminal 3 accepts a login operation of the crew member, for example, when the crew member arrives at work, and logs into the vehicle 2 for inspection or the like. As an alternative example, the vehicle 2 here may be a system that remotely monitors the vehicle 2. In step S4, the vehicle 2 authenticates an account to the information processing apparatus 1. In step S5, upon accepting an inspection result from the crew member, the crew member terminal 3 registers the inspection result in the information processing apparatus 1.

In step S6, the controller 11 notifies the manager terminal 4 of the inspection result. The manager terminal 4 displays the inspection result on the display 45. In step S7, the manager terminal 4 accepts, from the manager, an operation permission for the vehicle 2 and an adjustment request for operation of the vehicle 2.

In step S8, the controller 11 notifies the crew member terminal 3 of an operation table and cautionary points. The cautionary points include, for example, the following information associated with each other.
Date and time
Whether construction, accident, or event is taking place
Image or video link

In step S9, the crew member terminal 3 accepts an operation of the crew member and accesses the information processing apparatus 1 to check or view images or the like registered in advance in the information processing apparatus 1.

Steps S1 to S9 are optional or may be performed by another method.

In step S10, the controller 11 commands the crew member terminal 3 to input crew member information, for example, 15 minutes before boarding. As an additional example, a roll call bot may operate at the crew member terminal 3 to instruct input. In step S11, the controller 11 acquires, from the crew member terminal 3, the crew member information regarding the crew member. The crew member information includes at least one of the following items:
Identification information (e.g., 1589759)
Date (e.g., September 26, 222)
Body temperature (e.g., 36.1° C.)
Alcohol concentration
Sleep duration (e.g., 7 hours)
Facial expression
Clothing (e.g., buttoned up, wrinkled, stained)
Complexion
Hairstyle
Posture
Physical condition
Voice
Pitch
Speaking speed
Intonation

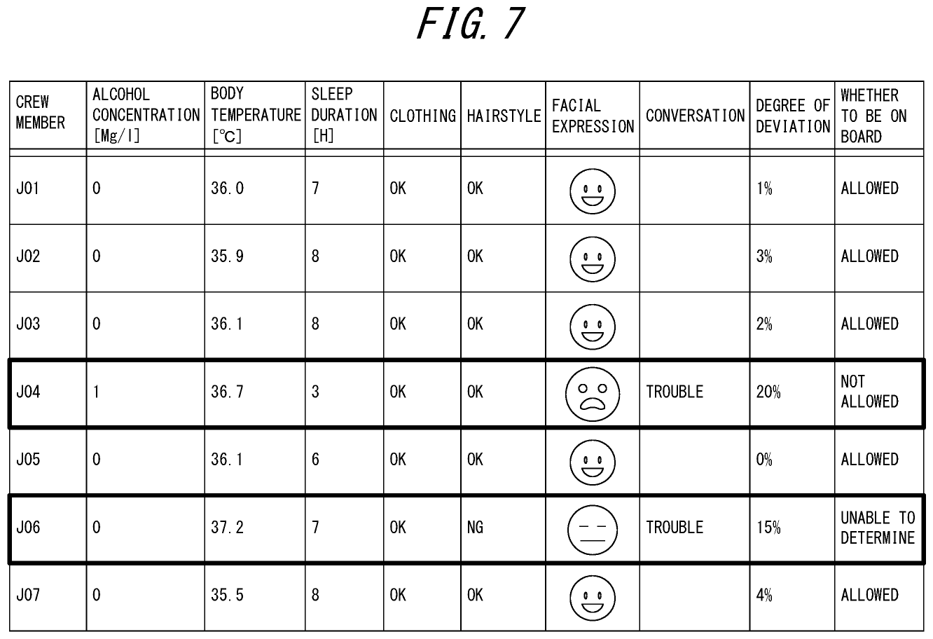

The crew member information may be input to the input interface 36 of the crew member terminal 3 or may be acquired using a camera or a microphone of the crew member terminal 3. As illustrated in FIG. 7, the controller 11 stores the crew member information in association with each crew member.

In step S12 of FIG. 6B following FIG. 6A, the controller 11 analyzes the crew member information and extracts feature values. The controller 11 compares the extracted feature values with pre-registered normal values to calculate the degree of deviation. The pre-registered normal values may be determined from a past history of the crew member himself/herself. As illustrated in FIG. 7, the controller 11 stores the degree of deviation in association with each crew member.

As an additional or alternative example, the degree of deviation may be calculated as a percentage. The controller 11 may set a weighting for each item in the calculation of the degree of deviation. The controller 11 may set weighted items for each crew member. Upon determining that the degree of deviation exceeds a threshold value, the controller 11 may question the crew member using a roll call bot operating at the crew member terminal 3. For example, when the hair and clothing of the crew member are in a mess and the voice of the crew member is low in pitch, the controller 11 asks the crew member, “You seem a little tired. Are you worried about something?” and receives a response, “I didn't sleep well last night, perhaps because of a family member in care.” The threshold value may be set or changed arbitrarily.

In step S13, the controller 11 determines, as primary roll call (i.e., primary screening), whether each crew member can be on board. Specifically, the controller 11 determines whether the calculated degree of deviation exceeds the threshold value, and determines that a crew member whose degree of deviation does not exceed the threshold value can be on board. As illustrated in FIG. 7, the controller 11 stores, in association with each crew member, whether the crew member can be on board.

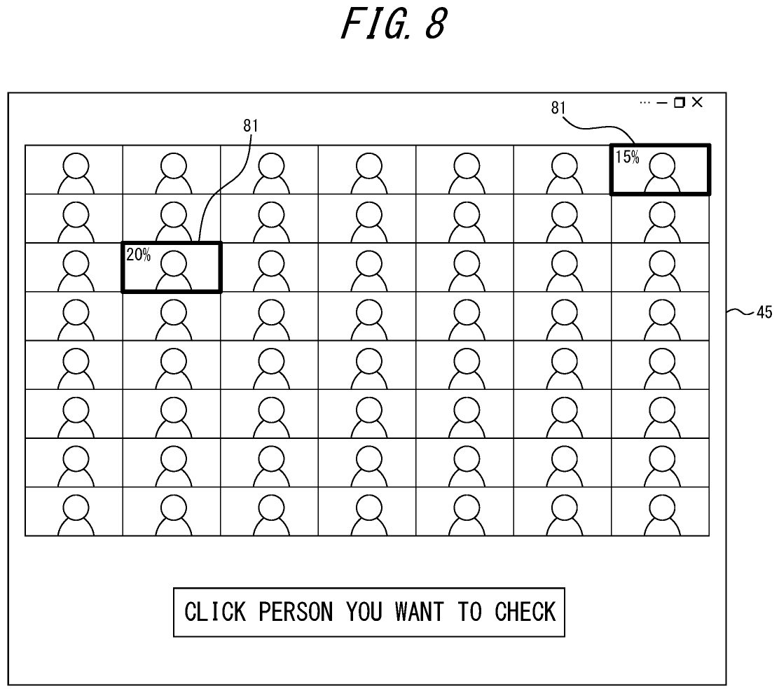

In step S14 of FIG. 6B, the controller 11 notifies the manager terminal 4 of primary determination results, which include at least whether each of the crew members can be on board. The manager terminal 4 displays the primary determination results on the display 45. As illustrated with the reference numeral 81 in FIG. 8, the display 45 may highlight crew members in poor physical condition whose degrees of deviation exceed the threshold value (here 10). On the display 45, each crew member is displayed in a selectable manner. The display 45 may display the degrees of deviation of the crew members.

In step S15 of FIG. 6B, the manager terminal 4 accepts, from the manager, a selection of a crew member in poor physical condition to be checked. The manager can call or otherwise contact the crew member in poor physical condition using the manager terminal 4, and update, according to a result of the contact, whether the crew member can be on board. Step S15 is optional. The manager terminal 4 accepts, from the manager, final determination results on whether each of the crew members can be on board. In step S16, the manager terminal 4 notifies the information processing apparatus 1 of the final determination results.

In step S17, the controller 11 notifies the crew member terminals 3 of crew members who are determined to be able to be on board in the final determination results that the crew members are allowed to be on board, and notifies the crew member terminals 3 of crew members who are determined to be unable to be on board that the crew members are not allowed to be on board. Upon determining that some final determination result is different from its primary determination result, the controller 11 may perform machine learning using the determination results as teacher data. With this configuration, accuracy in determination of the primary determination result is improved. The controller 11 issues accounts for logging into an operation system to the crew members who are determined to be able to be on board in the final determination results. The operation system is a system that can perform remote monitoring and the like. In the operation system, the crew member terminal 3 can view, for example, an operation route, a duration of boarding, cases that have recently occurred on the operation route, and the like.

In step S18, the crew member terminal 3 of the crew member who can be on board accepts a login operation of the crew member, and logs into the operation system for the vehicle 2. In step S19, the vehicle 2 authenticates an account to the information processing apparatus 1.

In step S20, the controller 11 starts operation of the vehicle 2 according to the operation plan.

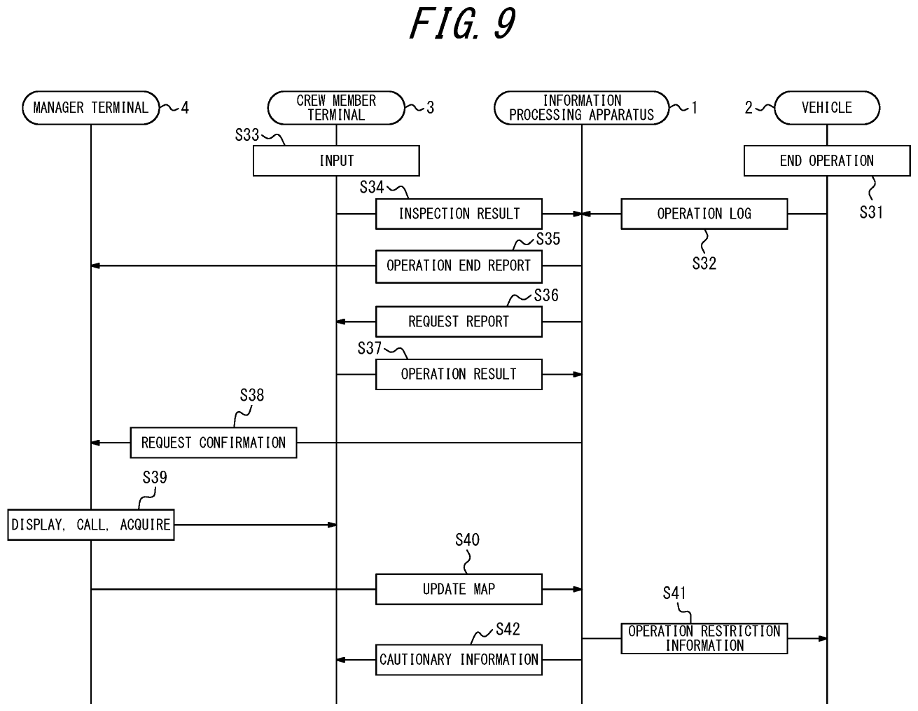

In FIG. 9, information processing to be performed after an end of the operation of the vehicle 2 will be described.

In step S31, the vehicle 2 ends the operation. In step S32, the vehicle 2 notifies the information processing apparatus 1 of an operation log acquired from a tachograph or the like.

In step S33, the crew member terminal 3 accepts, from the crew member, input of an inspection result. The inspection result may be, for example, a result of inspection as to the presence or absence of a forgotten item, dirt, or passengers in the vehicle 2. Steps S32 and S33 may be performed in reverse order. In step S34, the crew member terminal 3 notifies the information processing apparatus 1 of the inspection result.

In step S35, the controller 11 notifies the manager terminal 4 of an operation end report. In step S36, the controller 11 may request the crew member terminal 3 to report an operation result. Steps S35 and S36 may be performed in reverse order.

In step S37, the crew member terminal 3 acquires, from the crew member, for example, an alcohol concentration of the crew member and the operation result indicating a near-miss case that has occurred during the operation of the vehicle 2, and notifies the information processing apparatus 1. The near-miss case is a cautionary case that has not led, but may lead directly to a serious accident or disaster. The cautionary case may include the following, for example.
Pedestrian, bicycle, or the like jumping out from a blind spot and subsequent sudden stop
Road construction

The notification of the operation result may be made by text, image, and/or voice.

In step S38, the controller 11 requests the manager terminal 4 to confirm the operation result. In step S39, the manager terminal 4 displays the operation result on the display 45. The manager terminal 4 can, for example, make a call to the crew member terminal 3 of a crew member who has reported by voice. The controller 11 may acquire, from the crew member terminal 3, images recorded during the operation of the vehicle 2.

In step S40, the manager terminal 4 accesses the information processing apparatus 1 and updates an operation route map according to the cautionary information. At this time, for example, the cautionary information and/or operation restriction information according to the cautionary information is registered. The operation restriction information may be, for example, a speed limit at a particular location or a detour at the particular location.

In step S41, the controller 11 notifies the vehicles 2 of the operation restriction information. In step S42, the controller 11 notifies any crew member terminals of the cautionary information indicating the near-miss case. As an additional or alternative example, the controller 11 may notify any crew member terminals of the operation restriction information. Steps S41 and S42 may be performed in reverse order.

As described above, according to the present embodiment, the operations of the controller 11 include acquiring the crew member information from the crew member terminal 3 of the crew member of the vehicle 2, extracting the feature values from the crew member information, calculating the degree of deviation by comparing the feature values with the normal values, determining whether the crew member can be on board based on whether the degree of deviation exceeds the threshold value, notifying the manager terminal 4 of the primary determination result including whether the crew member can be on board, and acquiring, from the manager terminal 4, the final determination result on whether the crew member can be on board. With this configuration, since the information processing apparatus 1 makes primary determination, the manager (for example, operation management supervisor) can make final determination by only determining whether at least crew members who are in poor physical condition can be on board. Thus, the information processing apparatus 1 can reduce a burden of determination on the manager. Furthermore, the information processing apparatus 1 can reduce the need for an assistant of the manager. Furthermore, since the information processing apparatus 1 makes the primary determination, it is possible to reduce situations in which the determination result depends on the experience or physical condition of the manager.

According to the present embodiment, the crew member information includes body temperature, alcohol concentration, sleep duration, facial expression, clothing, complexion, hairstyle, posture, physical condition, voice, pitch, speaking speed, and/or intonation of the crew member. With this configuration, the information processing apparatus 1 can further improve accuracy in determining whether the crew member can be on board.

According to the present embodiment, the operations of the controller 11 also include questioning the crew member using the bot operating at the crew member terminal 3 when the degree of deviation is determined to exceed the threshold value. With this configuration, the crew member terminal 3 can easily detect an abnormality in the crew member owing to increased sensitivity to unusual condition.

According to the present embodiment, the operations of the controller 11 also include, in the calculation of the degree of deviation, setting the weighting for each item of the crew member information or for each crew member. With this configuration, the information processing apparatus 1 can more accurately determine whether the crew member can be on board.

According to the present embodiment, the operations of the controller 11 include issuing the account for logging into the operation system for the crew member who is determined to be able to be on board in the final determination result. With this configuration, the information processing apparatus 1 can eliminate unauthorized use while guaranteeing a legal basis by the roll call by information processing.

According to the present embodiment, the operations include acquiring, from the crew member terminal 3, the cautionary information indicating the cautionary case that has occurred during the operation of the vehicle 2, and notifying other crew member terminals of the cautionary information. The operations of the controller 11 include registering, in the operation route map, the cautionary information and/or the operation restriction information according to the cautionary information. With this configuration, the information processing apparatus 1 can promptly share, with the crew members, the cautionary information such as the near-miss information, and furthermore, prevent serious accidents from occurring.

While the present disclosure has been described with reference to the drawings and examples, it should be noted that various modifications and revisions may be implemented by those skilled in the art based on the present disclosure. Other modifications can be made without departing from the spirit of the present disclosure. For example, functions or the like included in each component or each step can be rearranged without logical inconsistency, and a plurality of components or steps can be combined into one or divided.

For example, in the above embodiment, a program that executes all or some of the functions or processing of the information processing apparatus 1, the vehicles 2, the crew member terminals 3, and the manager terminal 4 can be recorded on a computer readable recording medium. The computer readable recording medium includes a non-transitory computer readable medium and is, for example, a magnetic recording apparatus, an optical disc, a magneto-optical recording medium, or a semiconductor memory. The program is distributed, for example, by selling, transferring, or lending a portable recording medium such as a Digital Versatile Disc (DVD) or a Compact Disc Read Only Memory (CD-ROM) on which the program is recorded. The program may also be distributed by storing the program in a storage of any server and transmitting the program from any server to another computer. The program may be provided as a program product. The present disclosure can also be implemented as a program executable by a processor.

A computer temporarily stores in a main memory, for example, the program recorded on the portable recording medium, or the program transferred from the server. Then, the computer reads the program stored in the main memory using a processor, and executes processes in accordance with the read program using the processor. The computer may read the program directly from the portable recording medium, and execute processes in accordance with the program. The computer may, each time a program is transferred from the server to the computer, sequentially execute processes in accordance with the received program. Instead of transferring a program from the server to the computer, processes may be executed by a so-called ASP type service that realizes functions only by execution instructions and result acquisitions. The term “ASP” is an abbreviation of application service provider. The program encompasses information that is to be used for processing by an electronic computer and is thus equivalent to a program. For example, data that is not a direct command to a computer but has a property that regulates processing of the computer is “equivalent to a program” in this context.

Examples of some embodiments of the present disclosure are described below. However, it should be noted that the embodiments of the present disclosure are not limited to these examples.
[Appendix 1] An information processing apparatus comprising a controller configured to execute operations, the operations comprising:
   acquiring crew member information from a crew member terminal of a crew member of a vehicle;
   extracting a feature value from the crew member information;
   calculating a degree of deviation by comparing the feature value with a normal value;
   determining whether the crew member can be on board based on whether the degree of deviation exceeds a threshold value;
   notifying a manager terminal of a primary determination result including whether the crew member can be on board; and
   acquiring, from the manager terminal, a final determination result on whether the crew member can be on board.
[Appendix 2] The information processing apparatus according to appendix 1, wherein the crew member information includes body temperature, alcohol concentration, sleep duration, facial expression, clothing, complexion, hairstyle, posture, physical condition, voice, pitch, speaking speed, and/or intonation of the crew member.
[Appendix 3] The information processing apparatus according to appendix 1 or 2, wherein the operations comprise questioning the crew member using a bot operating at the crew member terminal when the degree of deviation is determined to exceed the threshold value.
[Appendix 4] The information processing apparatus according to any one of appendices 1 to 3, wherein the operations comprise, in the calculating of the degree of deviation, setting a weighting for each item of the crew member information or for each crew member.
[Appendix 5] The information processing apparatus according to any one of appendices 1 to 4, wherein the operations comprise issuing an account for logging into an operation system to a crew member who has been determined to be able to be on board in the final determination result.
[Appendix 6] The information processing apparatus according to any one of appendices 1 to 5, wherein the operations comprise acquiring, from the crew member terminal, cautionary information indicating a cautionary case that has occurred during operation of the vehicle, and notifying another crew member terminal of the cautionary information.
[Appendix 7] The information processing apparatus according to appendix 6, wherein the operations comprise registering, in an operation route map, the cautionary information and/or operation restriction information according to the cautionary information.
[Appendix 8] An information processing method by an information processing apparatus, the information processing method comprising:
   acquiring crew member information from a crew member terminal of a crew member of a vehicle;
   extracting a feature value from the crew member information;
   calculating a degree of deviation by comparing the feature value with a normal value;
   determining whether the crew member can be on board based on whether the degree of deviation exceeds a threshold value;
   notifying a manager terminal of a primary determination result including whether the crew member can be on board; and
   acquiring, from the manager terminal, a final determination result on whether the crew member can be on board.
[Appendix 9] The information processing method according to appendix 8, wherein the crew member information includes body temperature, alcohol concentration, sleep duration, facial expression, clothing, complexion, hairstyle, posture, physical condition, voice, pitch, speaking speed, and/or intonation of the crew member.
[Appendix 10] The information processing method according to appendix 8 or 9, comprising questioning the crew member using a bot operating at the crew member terminal when the degree of deviation is determined to exceed the threshold value.
[Appendix 11] The information processing method according to any one of appendices 8 to 10, comprising, in the calculating of the degree of deviation, setting a weighting for each item of the crew member information or for each crew member.
[Appendix 12] The information processing method according to any one of appendices 8 to 11, comprising issuing an account for logging into an operation system to a crew member who has been determined to be able to be on board in the final determination result.
[Appendix 13] The information processing method according to any one of appendices 8 to 12, comprising acquiring, from the crew member terminal, cautionary information indicating a cautionary case that has occurred during operation of the vehicle, and notifying another crew member terminal of the cautionary information.
[Appendix 14] The information processing method according to appendix 13, comprising registering, in an operation route map, the cautionary information and/or operation restriction information according to the cautionary information.
[Appendix 15] A program configured to cause a computer, as an information processing apparatus, to execute operations, the operations comprising:
   acquiring crew member information from a crew member terminal of a crew member of a vehicle;
   extracting a feature value from the crew member information;
   calculating a degree of deviation by comparing the feature value with a normal value;
   determining whether the crew member can be on board based on whether the degree of deviation exceeds a threshold value;
   notifying a manager terminal of a primary determination result including whether the crew member can be on board; and
   acquiring, from the manager terminal, a final determination result on whether the crew member can be on board.
[Appendix 16] The program according to appendix 15, wherein the crew member information includes body temperature, alcohol concentration, sleep duration, facial expression, clothing, complexion, hairstyle, posture, physical condition, voice, pitch, speaking speed, and/or intonation of the crew member.
[Appendix 17] The program according to appendix 15 or 16, wherein the operations comprise questioning the crew member using a bot operating at the crew member terminal when the degree of deviation is determined to exceed the threshold value.
[Appendix 18] The program according to any one of appendices 15 to 17, wherein the operations comprise, in the calculating of the degree of deviation, setting a weighting for each item of the crew member information or for each crew member.
[Appendix 19] The program according to any one of appendices 15 to 18, wherein the operations comprise issuing an account for logging into an operation system to a crew member who has been determined to be able to be on board in the final determination result.
[Appendix 20] The program according to any one of appendices 15 to 19, wherein the operations comprise acquiring, from the crew member terminal, cautionary information indicating a cautionary case that has occurred during operation of the vehicle, and notifying another crew member terminal of the cautionary information.

1. An information processing apparatus comprising a controller configured to execute operations, the operations comprising:
acquiring crew member information from a crew member terminal of a crew member of a vehicle;
extracting a feature value from the crew member information;
calculating a degree of deviation by comparing the feature value with a normal value;
determining whether the crew member can be on board based on whether the degree of deviation exceeds a threshold value;
notifying a manager terminal of a primary determination result including whether the crew member can be on board; and
acquiring, from the manager terminal, a final determination result on whether the crew member can be on board.

2. The information processing apparatus according to claim 1, wherein the crew member information includes body temperature, alcohol concentration, sleep duration, facial expression, clothing, complexion, hairstyle, posture, physical condition, voice, pitch, speaking speed, and/or intonation of the crew member.

3. The information processing apparatus according to claim 1, wherein the operations comprise questioning the crew member using a bot operating at the crew member terminal when the degree of deviation is determined to exceed the threshold value.

4. The information processing apparatus according to claim 1, wherein the operations comprise, in the calculating of the degree of deviation, setting a weighting for each item of the crew member information or for each crew member.

5. The information processing apparatus according to claim 1, wherein the operations comprise issuing an account for logging into an operation system to a crew member who has been determined to be able to be on board in the final determination result.

6. The information processing apparatus according to claim 1, wherein the operations comprise acquiring, from the crew member terminal, cautionary information indicating a cautionary case that has occurred during operation of the vehicle, and notifying another crew member terminal of the cautionary information.

7. The information processing apparatus according to claim 6, wherein the operations comprise registering, in an operation route map, the cautionary information and/or operation restriction information according to the cautionary information.

8. An information processing method by an information processing apparatus, the information processing method comprising:
acquiring crew member information from a crew member terminal of a crew member of a vehicle;
extracting a feature value from the crew member information;
calculating a degree of deviation by comparing the feature value with a normal value;
determining whether the crew member can be on board based on whether the degree of deviation exceeds a threshold value;
notifying a manager terminal of a primary determination result including whether the crew member can be on board; and
acquiring, from the manager terminal, a final determination result on whether the crew member can be on board.

9. The information processing method according to claim 8, wherein the crew member information includes body temperature, alcohol concentration, sleep duration, facial expression, clothing, complexion, hairstyle, posture, physical condition, voice, pitch, speaking speed, and/or intonation of the crew member.

10. The information processing method according to claim 8, comprising questioning the crew member using a bot operating at the crew member terminal when the degree of deviation is determined to exceed the threshold value.

11. The information processing method according to claim 8, comprising, in the calculating of the degree of deviation, setting a weighting for each item of the crew member information or for each crew member.

12. The information processing method according to claim 8, comprising issuing an account for logging into an operation system to a crew member who has been determined to be able to be on board in the final determination result.

13. The information processing method according to claim 8, comprising acquiring, from the crew member terminal, cautionary information indicating a cautionary case that has occurred during operation of the vehicle, and notifying another crew member terminal of the cautionary information.

14. The information processing method according to claim 13, comprising registering, in an operation route map, the cautionary information and/or operation restriction information according to the cautionary information.

15. A non-transitory computer readable medium storing a program configured to cause a computer, as an information processing apparatus, to execute operations, the operations comprising:
acquiring crew member information from a crew member terminal of a crew member of a vehicle;
extracting a feature value from the crew member information;
calculating a degree of deviation by comparing the feature value with a normal value;
determining whether the crew member can be on board based on whether the degree of deviation exceeds a threshold value;
notifying a manager terminal of a primary determination result including whether the crew member can be on board; and
acquiring, from the manager terminal, a final determination result on whether the crew member can be on board.

16. The non-transitory computer readable medium according to claim 15, wherein the crew member information includes body temperature, alcohol concentration, sleep duration, facial expression, clothing, complexion, hairstyle, posture, physical condition, voice, pitch, speaking speed, and/or intonation of the crew member.

17. The non-transitory computer readable medium according to claim 15, wherein the operations comprise questioning the crew member using a bot operating at the crew member terminal when the degree of deviation is determined to exceed the threshold value.

18. The non-transitory computer readable medium according to claim 15, wherein the operations comprise, in the calculating of the degree of deviation, setting a weighting for each item of the crew member information or for each crew member.

19. The non-transitory computer readable medium according to claim 15, wherein the operations comprise issuing an account for logging into an operation system to a crew member who has been determined to be able to be on board in the final determination result.

20. The non-transitory computer readable medium according to claim 15, wherein the operations comprise acquiring, from the crew member terminal, cautionary information indicating a cautionary case that has occurred during operation of the vehicle, and notifying another crew member terminal of the cautionary information.
